(19) United States
(12) Patent Application Publication
(10) Pub. No.: US 2025/0250968 A1
(43) Pub. Date: Aug. 7, 2025

(54) BISTABLE CELLS AND INFLATABLE MEMBRANES INCLUDING BISTABLE CELLS

(71) Applicant: Toyota Motor Engineering & Manufacturing North America, Inc., Plano, TX (US)

(72) Inventors: Koray Benli, Ann Arbor, MI (US); Yuyang Song, Ann Arbor, MI (US); Umesh N. Gandhi, Farmington Hills, MI (US); Shinnosuke Shimokawa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/432,153

(22) Filed: Feb. 5, 2024

(51) Int. Cl. F03G 1/02; F16F 3/087

(52) U.S. Cl. CPC F03G 1/029; F03G 1/032; F16F 3/0876

(57) ABSTRACT

Apparatuses described herein relate to improving the shape morphing of structures using bistable cells. In one embodiment, an inflatable structure comprises an inflatable membrane with an inner top surface and an inner bottom surface opposite the inner top surface. The inflatable structure further comprises an array of vertically stacked bistable cells with a first end attached to the inner top surface and a second end attached to the inner bottom surface, where each of the bistable cells of the array is configured to change from a first state to a second state according to a change in pressure within the inflatable membrane.

### TECHNICAL FIELD

The subject matter described herein relates, in general, to bistable cells, and, more particularly, to bistable cells that change states in response to an external force.

### BACKGROUND

Various approaches and technologies are used to facilitate shape morphing of structures. Conventional shape morphing approaches include employing electromechanical systems (e.g., linear actuators, linkage mechanisms, electronic control components, etc.) or hydraulic/pneumatic systems (e.g., inflatable bellow actuators, tubing, and valving systems, etc.) that require the use of large, complex, and/or many different components to accomplish shape morphing. Accordingly, it is difficult to integrate these approaches into existing systems, such as into automobiles, due to the size and complexity of the existing technology. Furthermore, the number of components needed to successfully apply the conventional shape morphing techniques renders shape morphing technology costly and difficult to transport.

### SUMMARY

In one embodiment, an inflatable structure is disclosed. The inflatable structure comprises an inflatable membrane with an inner top surface and an inner bottom surface opposite the inner top surface. The inflatable structure further comprises an array of vertically stacked bistable cells with a first end attached to the inner top surface and a second end attached to the inner bottom surface. Each of the bistable cells of the array is configured to change from a first state to a second state according to a change in pressure within the inflatable membrane.

In another embodiment, a bistable cell is disclosed. The bistable cell includes a frame having a perimeter and recesses defined by the perimeter. The bistable cell further includes bistable components at least partially disposed within the recesses and having a length greater than a length of the recesses. The bistable components are configured to change from a first state to a second state when an external stimulus is applied (e.g., an external force).

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A-1B illustrate one embodiment of an inflatable structure that includes an array of vertically stacked bistable cells that change states in response to an external force.

FIGS. 2A-2D illustrate one embodiment of a plurality of arrays of vertically stacked bistable cells that change states in response to an external force.

FIG. 3 illustrates one embodiment of a bistable cell that changes states in response to an external force.

FIGS. 4A-4B illustrate one embodiment of an array of vertically stacked bistable cells that change from a retracted state to an extended state in response to an external force.

FIG. 5 illustrates an exploded view of a bistable cell illustrated in FIGS. 4A-4B.

FIG. 6 shows an illustrative example of an array of vertically stacked bistable cells in an extended state.

### DETAILED DESCRIPTION

Example apparatuses associated with improving shape morphing technology are disclosed herein. As previously discussed, current methods of facilitating shape morphing involve the use of large, complex, and expensive systems that are difficult to integrate into practical applications. Therefore, in one embodiment, an inflatable structure capable of morphing shapes is disclosed. In one aspect, the inflatable structure is lightweight and simple, resulting in a shape morphing technique that is both inexpensive and easy to integrate with other systems, such as in automobiles.

In one approach, an inflatable structure includes a fluid tight inflatable membrane. Located within the inflatable membrane are an array of vertically stacked bistable cells with a first end attached to an inner top surface of the inflatable membrane and a second end attached to an inner bottom surface of the inflatable membrane. The bistable cells may include a frame having a perimeter and recesses defined by the perimeter as well as bistable components at least partially disposed within the recesses and having a length greater than a length of the recesses.

The bistable components are, in one arrangement, configured to change from a first state, such as a retracted state, to a second state, such as an extended state, according to a change in pressure within the inflatable membrane. For example, as a fluid is introduced into the inflatable membrane, the inflatable membrane will inflate causing the bistable cells to change from the first state to the second state. As such, the inflatable structure essentially morphs from one shape to another when the air appropriate force, such as a force provided when inflating the inflatable membrane, causes the bistable cells to change from the first state to the second state.

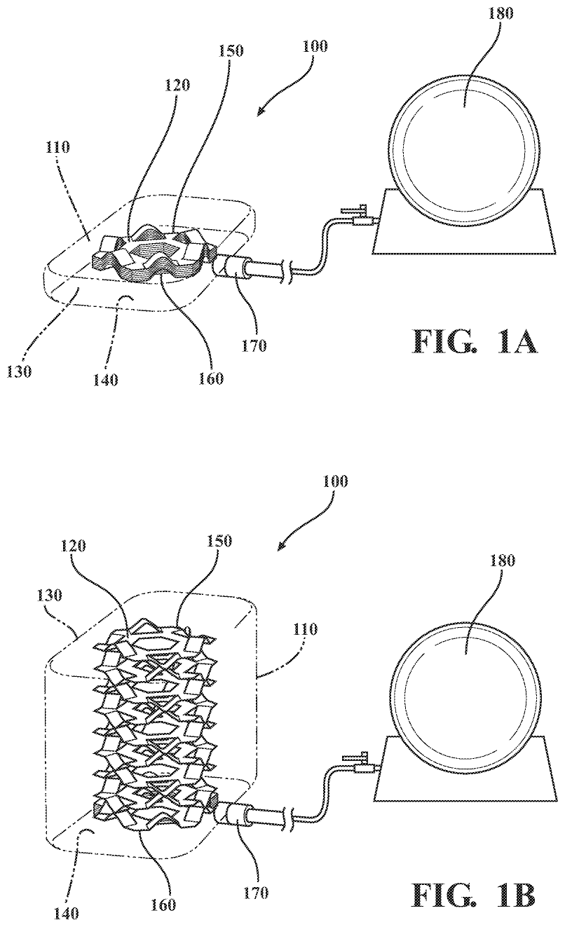

Referring to FIGS. 1A-1B, one embodiment of an inflatable structure 100 is illustrated. The inflatable structure 100, in one approach, includes an inflatable membrane 110. The inflatable membrane 110 is, for example, an apparatus that is configured to change between a flat state and one or more extended/inflated states in response to receiving a fluid, such as air or water. In one configuration, the inflatable membrane 110 is lightweight and comprises an airtight material, such as a heat sealable thermoplastic (e.g., polyurethane, polypropylene, etc.), a thermoplastic coated fabric (e.g., a fabric, such as nylon, coated in a thermoplastic material, such as polyurethane), rubber, or silicone. In one approach, the inflatable structure 100 further includes an array 120 of vertically stacked bistable cells attached to the inflatable membrane 110. In particular, the inflatable membrane 110, in one arrangement, includes an inner top surface 130 and an inner bottom surface 140 opposite the inner top surface 130, where a first end 150 of the array 120 is tethered to the inner top surface 130 and a second end 160 of the array 120 is tethered to the inner bottom surface 140.

The first ends 150 and the second ends 160 of the array 120 may be tethered to the inflatable membrane 110 using various techniques, such as via stitching, adhesives (e.g., glue, tape, etc.), thermal bonding (e.g., heat pressing/ultrasonic welding), being additively manufactured using multiple materials as a monolithic structure (e.g., an FDM 3D printing using a range of different materials to fabricate different components in the entire structure layer by layer), and so on. In one embodiment, where the array 120 is stitched to the inflatable membrane 110, the inflatable membrane 110 includes a heat scalable coating on its exterior, such as a thermoplastic coating, to prevent fluid leakage when the inflatable membrane 110 is in an inflated state.

The array 120 may include any number of bistable cells attached to one another. In one approach, the array 120 includes at least three bistable cells. However, it should be understood that, in one or more variations, more or less bistable cells may form the array 120. Detailed views of the bistable cells will be disclosed later in this description. The bistable cells are, in one embodiment, attached to one another to form the array 120. Attachment of the bistable cells may be facilitated by a variety of techniques. For example, the bistable cells may be attached via the bistable components of the bistable cells using injection molding, thermal bonding (e.g., heat pressing, ultrasonic welding, etc.), three-dimensional (3D) printing, snaps, adhesives, or other known attachment techniques. In any case, each of the bistable cells of the array 120 is configured to change from a first state to a second state according to a change in pressure within the inflatable membrane 110. FIG. 1A shows an illustrative example of the inflatable structure 100 in a first state that correlates with each of the bistable cells of the array 120 being in a first state, where the first state is a retracted state. In the example shown in FIG. 1A, the pressure within the inflatable membrane 110 is zero pounds per square inch (psi).

In one configuration, the inflatable structure 100 further includes a pneumatic/hydraulic fitting 170. The pneumatic/hydraulic fitting 170 is, in one embodiment, configured to be coupled to a supply device 180, such as an external air source. The pneumatic/hydraulic fitting 170 may be coupled to the supply device 180 using a connection channel, such as a hose, tube, pipe, etc. Where the supply device 180 is an external air source, the external air source is, for example, a pump, an air tank, compressor, or other source of air. When the external air source supplies air via the connection channel to the pneumatic/hydraulic fitting, the inflatable membrane 110 receives air, resulting in an internal change in pressure within the inflatable membrane 110. In one approach, the supply device 180 may be any kind of external fluid source that can fill the inflatable membrane 110, such as an external water source. In any case, the supply device 180 supplies fluid to the inflatable membrane 110 which results in a change in pressure within the inflatable membrane 110.

FIG. 1B illustrates the inflatable structure 100 in a second state that correlates with each of the bistable cells in the array 120 being in a second extended state. Although FIG. 1B shows the inflatable structure 100 in a fully extended state, it should be understood that, in one or more embodiments, the inflatable structure 100 may change into additional states in between the fully retracted state shown in FIG. 1A and the fully extended state shown in FIG. 1B depending on the states of each individual bistable cell forming the vertical stack, such as a ramp-like state, partially inflated state, and so on. In one arrangement, the inflatable structure 100 remains in any state between the states shown in FIGS. 1A and 1B until the pressure within the inflatable structure 100 changes or until an external force acts upon the inflatable structure 100 in a manner that causes the inflatable structure 100 to change states. In any case, the inflatable structure 100 conforms to the shape of the retracted/extended bistable cells due to the inflatable membrane 110 being attached to the inflatable membrane 110. Accordingly, when the inflatable membrane 110 is retracted, the inflatable structure 100 remains flat. In contrast, when the inflatable membrane 110 is fully extended, the inflatable structure 100 extends accordingly.

As shown in FIG. 1B, responsive to a change in pressure within the inflatable membrane 110, each of the bistable cells of the array 120 changes states. The change in pressure may be any change in pressure that causes the bistable cells of the array 120 to change states (e.g., five psi, ten psi, twenty psi, etc.). After the bistable cells of the array 120 change states to an extended state, the pressure within the inflatable membrane 110 does not need to be sustained in order to keep the bistable cells in the second state. In particular, by the bistable cells experiencing a change in pressure in a first instance that causes the bistable cells to change states to an extended state, the bistable cells remain in the extended state until a force, such as physical movement of the bistable cells or vacuuming of the air within the inflatable membrane 110, occurs.

In one approach, the change in pressure that causes the bistable cells of the array 120 to change states depends on a material property of at least one bistable component forming the bistable cells. The material property includes a cross-sectional design and in particular shape, thickness, a width, a material type, and a stiffness of the bistable components forming the bistable cells. In particular, the thicker the cross-sectional thickness of the bistable components, the higher the pressure must be within the inflatable membrane 110 to cause the bistable components to change states. Additionally, depending on the cross-sectional shape of the bistable component, the bistable component may require a different pressure within the inflatable membrane 110 to change states. For example, a rectangular cross-section shape bistable component may change states according to a different pressure within the inflatable membrane 110 than a bistable component with an ellipse-like shape, a dog-bone shape etc. Further, the wider the bistable components are, the higher the pressure must be within the inflatable membrane 110 to cause the bistable components to change states. Moreover, the stiffer/harder a material of the bistable components are, the higher the pressure must be within the inflatable membrane 110 to cause the bistable components to change states. For example, a polyurethane bistable component that has a Shore A hardness of ninety-five, a cross-sectional thickness of ten millimeters (mm), and a width of ten mm requires a higher pressure to change states than a polyurethane bistable component that has a Shore A hardness of seventy-five, a cross-sectional thickness of five mm, and a width of five mm. As another example, a polyurethane bistable component with a cross-sectional thickness of ten mm, and a width of ten mm requires a higher pressure to change states than a silicone bistable component with a cross-sectional thickness of ten mm, and a width of ten mm due to the stiffness of polyurethane being higher than that of silicone.

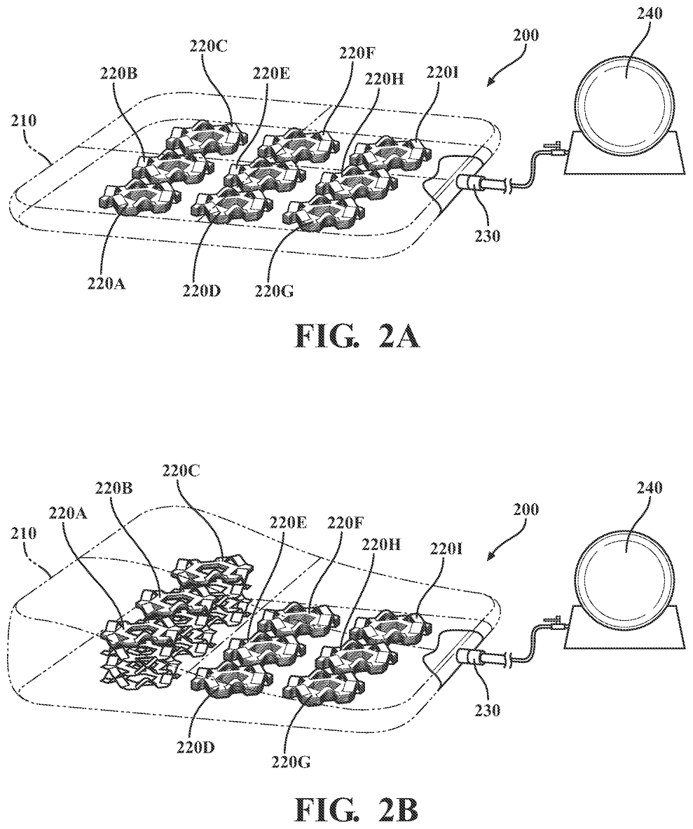

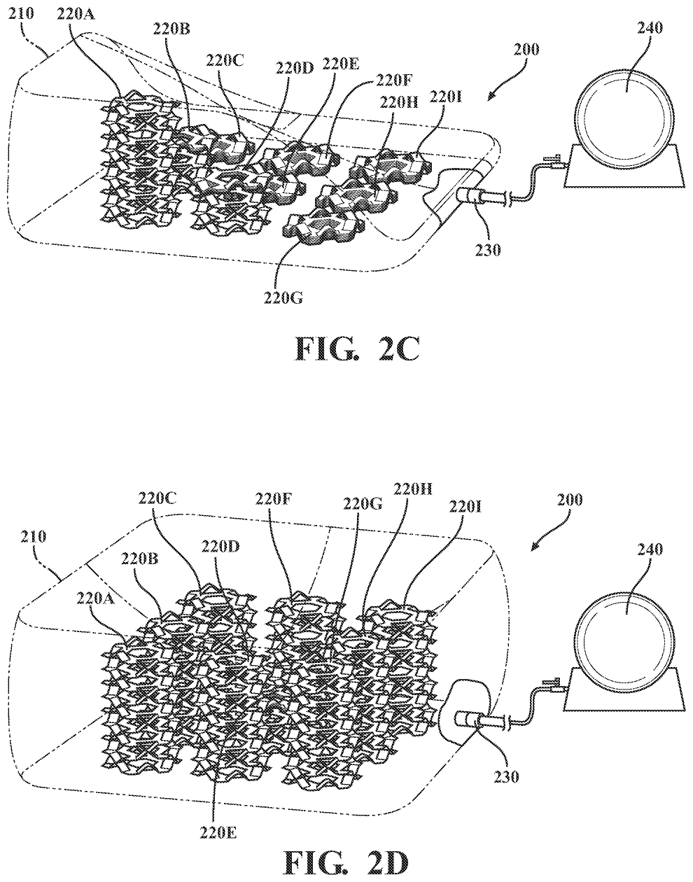

Although FIG. 1B illustrates the inflatable structure 100 as including one array 120, it should be understood that in one or more arrangements, the inflatable structure may include a plurality of arrays of bistable cells. Discussion will now turn to FIGS. 2A-2D to further explain how an inflatable structure can change states when the inflatable structure includes a plurality of vertically stacked arrays of bistable cells.

FIGS. 2A-2D illustrate an inflatable structure 200 in a first state, a second state, a third state, and a fourth state, respectively. As previously discussed with reference to FIGS. 1A-1B, the inflatable structure 200 includes an inflatable membrane 210, a plurality of arrays 220A-220I of vertically stacked bistable cells, and a pneumatic/hydraulic fitting 230 coupled to a supply device 240. Although FIGS. 2A-2D illustrate the inflatable structure 200 as having nine arrays 220A-220I of bistable cells that are evenly distributed throughout the inflatable structure 200, any number of bistable cells arranged in any manner may be included within the inflatable structure 200. For example, the inflatable structure 200 may include less or more than nine arrays, where the arrays may be arranged in a single row/column, multiple rows/columns, in a pattern, and so on.

Each of the arrays 220A-220I of the plurality of arrays may include the same number of bistable cells, a different number of bistable cells, the same type of bistable cells, and/or different types of bistable cells. In one embodiment, bistable cells of one of the arrays of the plurality of arrays differ from the bistable cells of another array of the plurality of arrays by at least one of a material of the bistable cells, a shape of the bistable cells, a length of the bistable cells, a thickness of the bistable cells, and a width of the bistable cells. As previously discussed with reference to FIGS. 1A-1B, the material, shape, thickness, width, and stiffness of the bistable cells affect the time at which a bistable component of a bistable cell changes states as a function of the force applied on each cell due to the changing air pressure inside the structure. As shown in FIG. 2A, the supply device 240 is supplying no fluid to the inflatable membrane 210, and the pressure within the inflatable membrane 210 is zero psi. Thus, all of the bistable cells of the plurality of arrays 220A-220I are in a first retracted state.

Referring to FIG. 2B, the supply device 240 supplies the inflatable membrane 210 with air in a manner that causes the inflatable membrane 210 to have an internal pressure of five psi. As shown in FIG. 2B, arrays 2A-2C located on the far-left side of the inflatable membrane 210 change states to a second extended state while the remaining arrays (220D-220I) remain in the first retracted state. Accordingly, the inflatable structure 200 takes on a first ramp state and remains in the first ramp state until the pressure changes within the inflatable membrane 210.

Referring to FIG. 2C, the supply device 240 supplies the inflatable membrane 210 with air in a manner that causes the inflatable membrane 210 to have an internal pressure of ten psi. As shown in FIG. 2C, array 220A located on the far-left side of the inflatable membrane 210 is in a third fully extended state while several other arrays are in partially extended states (i.e., arrays 220B-220D), and while still other arrays (i.e., arrays 220E-220I) remain in the first retracted state. Accordingly, the inflatable structure 200 takes on a second ramp state and remains in the second ramp state until the pressure changes within the inflatable membrane 210.

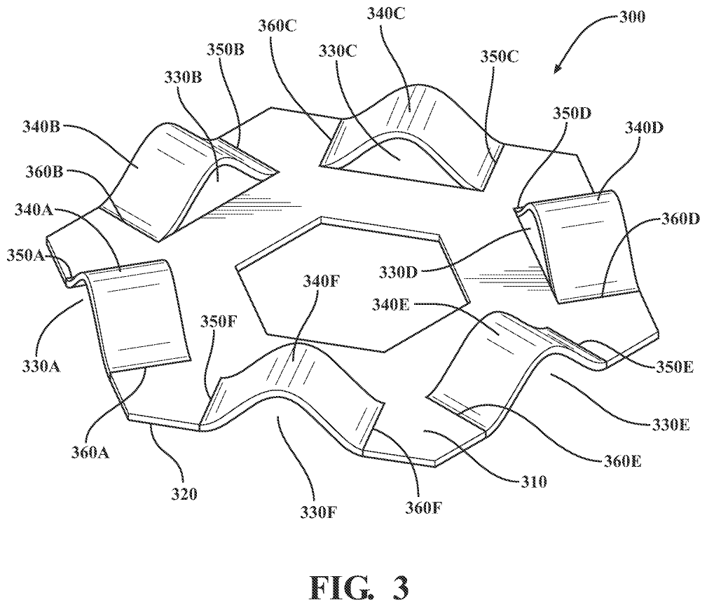

Referring to FIG. 2D, the supply device 240 supplies the inflatable membrane 210 with air in a manner that causes the inflatable membrane 210 to have an internal pressure of fifteen psi. As shown in FIG. 2D, all of the arrays 220A-220I are in a fully extended state. Accordingly, the inflatable structure 200 takes on a fully extended state and remains in the fully extended state until the pressure changes within the inflatable membrane 210. Although the pressures discussed in relation to FIGS. 2B-2D range between five and fifteen psi, it should be understood that depending on the overall design of the bistable cells, which may include a material, width, cross-sectional thickness, cross-sectional shape, and stiffness of components of the bistable cells, other pressures may be necessary to cause the bistable cells of the plurality of arrays 220A-220I to change states. Further, additional states may exist between the fully retracted state illustrated in FIG. 2A and the fully extended state 2D depending on the material, width, cross-sectional thickness, cross-sectional shape, and stiffness of components of the bistable cells as well as the pressure supplied to the inflatable membrane 210. Discussion will now turn to FIGS. 3-6 to further explain the structure of the bistable cells.

FIG. 3 illustrates one embodiment of a bistable cell 300 that changes states in response to an external force. In one configuration, the bistable cell 300 includes a frame 310 having a perimeter 320 and recesses 330A-330F defined by the perimeter 320. The recesses 330A-330F may form any shape as defined by the recess. For example, as illustrated in FIG. 3, the recesses 330A-330F may comprise three edges resembling the outline of three sides of a rectangle. As another example, the recesses 330A-330F may comprise an edge that resembles a curved shape (e.g., resembling a half circle or crescent shape), edges that form a triangular shape, or any other number of edges. Further, the edges of the recesses 330A-330F may comprise any length, where the edges of each recess 330A-330F may be the same and/or different lengths. Although FIG. 3 illustrates the bistable cell 300 as comprising six recesses 330A-330F, it should be understood that the perimeter 320 may define any number of recesses (i.e., the perimeter 320 may form more or less than six recesses).

In one embodiment, the bistable cell 300 further includes bistable components 340A-340F at least partially disposed within the recesses 330A-330F and having a length greater than a length of the recesses 330A-330F. As previously discussed with reference to FIGS. 1A-2D, the bistable components 340A-340F are configured to change from a first state to a second state, where the first state is a retracted state, and the second state is an extended state in response to an external force. In one arrangement, the bistable components 340A-340F are at least partially disposed within the recesses 330A-330F and have a length greater than a length of the recesses. The bistable cell 300 may include any number of bistable components such that the number of bistable components is equal to the number of recesses (e.g., three recesses and three bistable components, six recesses and six bistable components, ten recesses and ten bistable components, etc.). The bistable components 340A-340F may comprise any material that can change between a first and a second state in response to an external force. For example, the bistable components 340A-340F may comprise a thermoplastic material, such as polyurethane or polypropylene, silicone, or any other material. In one approach, the bistable components 340A-340F comprise a combination of materials, such as a combination of thermoplastic polyurethane and polypropylene. Further, each bistable component 340A-340F of the bistable cell 300 may differ in material, cross-sectional thickness, cross-sectional shape, length, and/or width from another bistable component 340A-340F of the bistable cell 300 or another bistable cell of an array of vertically stacked bistable cells. Additionally, in one or more variations, each bistable component 340A-340F of the bistable cell 300 may be the same material, cross-sectional thickness, cross-sectional shape, and/or width as another bistable component 340A-340F of the same bistable cell 300 or another bistable cell of an array of vertically stacked bistable cells. In any case, differences in the bistable components 340A-340F result in the bistable components 340A-340F changing states according to different external forces.

As shown in FIG. 3, the bistable components 340A-340F have a first end 350A-350F and a second end 360A-360F, the first end 350A-350F of the bistable components 340A-340F attached to one portion of an edge of the recesses 330 and the second end 360A-360F of the bistable components 340A-340F attached to another portion of the edge of the recesses 330. The bistable components 340A-340F may be attached to the recesses 330 using a variety of attachment mechanisms, such as adhesives, injection molding, snaps, 3D printing, etc. Due to the length of the bistable components 340A-340F being greater than the length of the recesses 330, the bistable components 340A-340F, in one embodiment, form a U-shape when in the first or second state. In one approach, the frame 310 is formed from a material that is more rigid than the material that forms the bistable components 340A-340F. For example, the frame 310 may be formed from polylactic acid (PLA), or any other rigid plastic while the bistable components 340A-340F are a less rigid, flexible material, such as a thermoplastic polyurethane material, silicone material, etc.

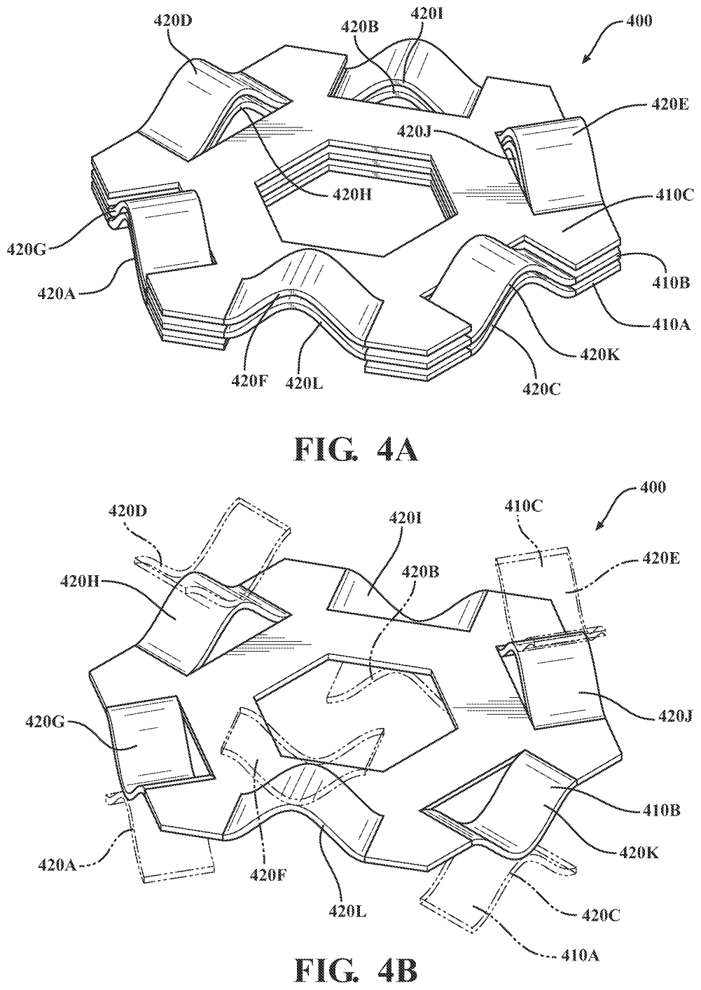

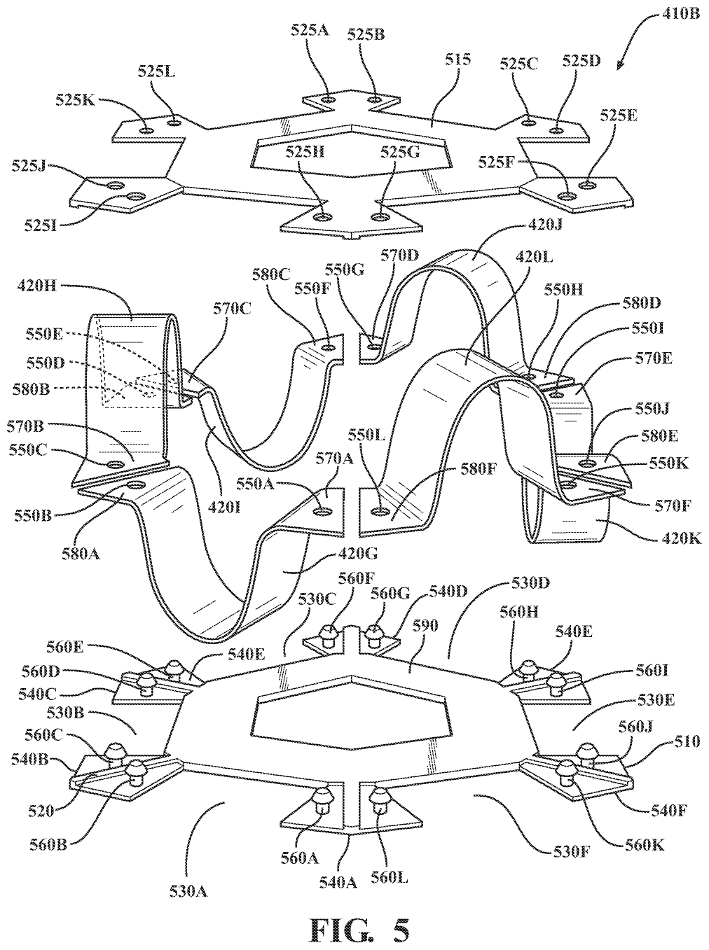

FIGS. 4A-4B illustrate one embodiment of an array 400 of vertically stacked bistable cells 410A-410C that change from a retracted state to an extended state in response to an external force. As previously discussed, the bistable cells 410 are attached to one another via bistable components 420A-420L using various techniques, such as injection molding, adhesives, thermal bonding (e.g., ultrasonic welding, heat pressing, etc.), 3D printing, etc. FIG. 4A illustrates the bistable cells 410A-410C in a retracted state. As illustrated, the array 400 includes three vertically stacked bistable cells 410A-410C. However, it should be understood that in one or more arrangements, additional bistable cells may be included in the array 400. The bistable cells 410A-410C remain in the retracted state until an external force, such as a change in pressure or physical/manual movement/manipulation, causes the bistable components of the bistable cells 410A-410C to change states.

As illustrated in FIGS. 4A-4B, the bistable cells 410A and 410C comprise three bistable components 420A-420C and 420D-420F, respectively while the bistable cell 410B comprises six bistable components 420G-420L. In one approach, the bistable cells 410A and 410C comprise only three bistable components 420A-420F because each of the bistable components 420A-420F corresponds to one of the six bistable components 420G-420L. Although the bistable cells 410A and 410 C are illustrated as comprising three bistable components, and the bistable cell 410B is illustrated as having six bistable comonents, it should be understood that, in one or more arrangements, the bistable cells 410A-410C may have any number of bistable components such that each bistable component of bistable cell 410B corresponds to one bistable component of bistable cells 420A and 420C. Where the array 400 includes more than three bistable cells, in one embodiment, every other bistable cell has double the amount of bistable cells as the bistable cells in between to ensure that each outer bistable component of each bistable cell is attached to only one other bistable component of another bistable cell. In this way, when an external force cause a bistable component to change states, the bistable component is able to expand/retract.

FIG. 4B illustrates the bistable cells 410A-410C in the extended states. As illustrated in FIG. 4B, the extended bistable cells include bistable components 420A-420L that change states (i.e., from an upward position to a downward position or a downward position to an upward position in relation to a frame of the bistable cells 410A-410C). The bistable cells 410A-410C remain in the extended state until an external force, causes the bistable components 420A-420L of the bistable cells 410A-410C to change states.

FIG. 5 illustrates an exploded view of one example of the bistable cell 410B illustrated in FIGS. 4A-4B. As previously discussed with reference to FIG. 3, the bistable cell 410B includes a frame 510 having a perimeter 520 and recesses 530A-F defined by the perimeter 520 as well as the bistable components 420G-420L. In one embodiment, the recesses 530A-530F are separated by a plurality of protruding surfaces 540A-540F. The bistable components 420A-420G are attached to the protruding surfaces 540A-540F using sockets 550A-550L of the bistable components 420G-420L and studs 560A-560L of the protruding surfaces 540A-540F. As shown, the bistable components 420G-420L, in one embodiment, comprise a first end 570A-570F and a second end 580A-580F, where the first ends 570A-570F include first sockets 550A, 550C, 550E, 550G, 550I, and 550K and the second ends 580A-580F include second sockets 550B, 550D, 550F, 550H, 550J, and 550L. In one arrangement, the first sockets 550A, 550C, 550E, 550G, 550I, and 550K are coupled to first studs 560A, 560C, 560E, 560G, 560I, and 560K, respectively associated with the protruding surfaces 540A-540F of a first side 590 of the frame 510 and the second sockets 550B, 550D, 550F, 550H, 550J, and 550L are coupled to second studs 560B, 560D, 560F, 560H, 560J, and 560L associated with the protruding surfaces 540A-540F of the first side 590 of the frame 510. In one configuration, the frame 510 further includes a second side 515 that sandwiches the bistable components 420G-420L between the first side 590 and the second side 515 of the frame 510 via sockets 525A-525L that are on the second side 515 of the frame 510. In this way, the bistable components 420A-420L are secured by the frame 510.

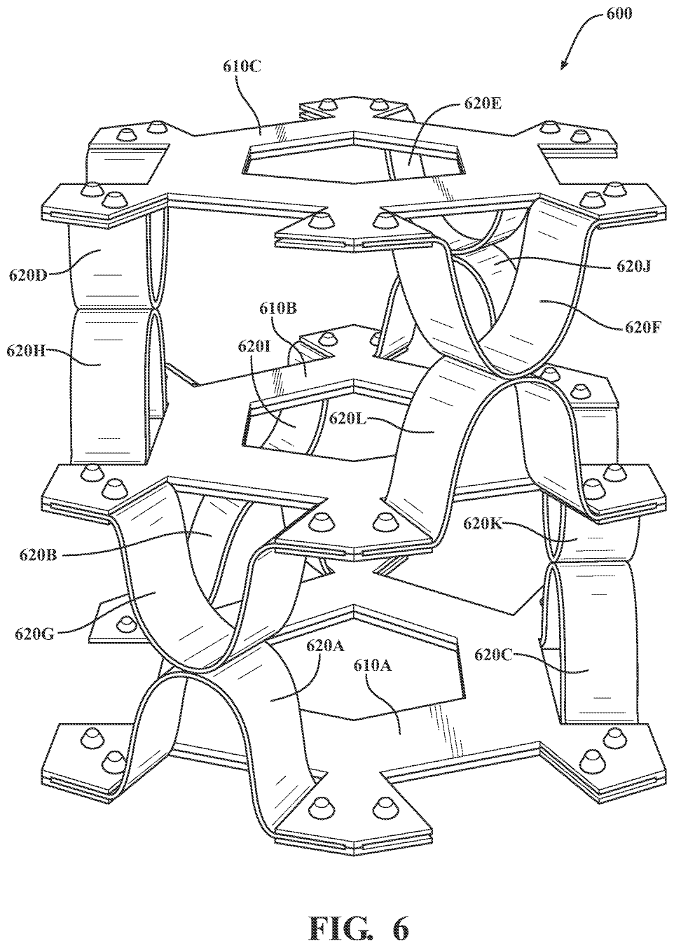

FIG. 6 shows an illustrative example of an array 600 of vertically stacked bistable cells 610A-610C in an extended state. In one embodiment, the bistable cells 610 are attached to one another via the bistable components 620A-620L of the bistable cells 610, where bistable components 620A-620C are bistable components of bistable cell 610A, bistable components 620D-620F are bistable components of bistable cell 610C, and bistable components 620G-620L are bistable components of bistable cell 610C. As illustrated in FIG. 6, when the bistable cells 610A-610C are in an extended state, the array 600 stands as a stable column. As previously discussed, the bistable cells 610A-610C may move to an extended state in response to an appropriate external force, such as physical manipulation or a change in pressure. The array 600 remains in the extended state until another external force causes the bistable cells 610A-610C to change to the retracted state. In one approach, the individual bistable components 620A-620L can change states inependent of the other bistable components 620A-620L of the bistable cells 610A-610C according to an applied external force on each of the bistable components 620A-620L. For example, a user may push down one side of the array 600 which causes the bistable components 620A-620L on the side that was pushed to retract while the bistable components 620A-620L that were not pushed down remain extended. In this way, the bistable cells disclosed herein provide an improved shape morphing technique that is lightweight, simple, and easily integratable into other structures.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An inflatable structure comprising:
an inflatable membrane with an inner top surface and an inner bottom surface opposite the inner top surface; and
an array of vertically stacked bistable cells with a first end attached to the inner top surface and a second end attached to the inner bottom surface, and wherein each of the bistable cells of the array is configured to change from a first state to a second state according to a change in pressure within the inflatable membrane.

2. The inflatable structure of claim 1, further comprising a pneumatic/hydraulic fitting coupled to the inflatable membrane, wherein the pneumatic/hydraulic fitting is configured to be connected to an external air source, and wherein the external air source causes the change in pressure.

3. The inflatable structure of claim 1, wherein the pressure causes each of the bistable cells of the array to change from the first state to the second state that is based, at least in part, on a material property of at least one components forming the bistable cells, the material property including at least one of a cross-sectional shape, a cross-sectional thickness, a width, a length, a material, and a stiffness of the at least one components forming the bistable cells.

4. The inflatable structure of claim 1, wherein each of the bistable cells is connected to another of the bistable cells using at least one of: injection molding, thermal bonding, three-dimensional (3D) printing, and adhesive bonding.

5. The inflatable structure of claim 1, wherein the inflatable structure includes a plurality of arrays of vertically stacked bistable cells tethered to the inner top surface and the inner bottom surface.

6. The inflatable structure of claim 5, wherein the bistable cells of one array of the plurality of arrays differ from the bistable cells of another array of the plurality of arrays by at least one of: a material of the bistable cell, a cross-sectional shape of the bistable cell, a cross-sectional thickness of the bistable cell, a width of the bistable cell, a length of the bistable cell, and a stiffness of the at least one components forming the bistable cells.

7. The inflatable structure of claim 5, wherein each array is configured to change from the first state to the second state according to individual changes in the pressure.

8. The inflatable structure of claim 1, wherein the inflatable membrane is configured to change from a first position to a second position according to a first change in pressure, to change from the second position to a third position according to a second change in pressure, and to change from the third position to a fourth position according to a third change in pressure.

9. The inflatable structure of claim 8, wherein the first position is a flat position, the second position is a first ramp position, the third position is a second ramp position, and the fourth position is a fully extended position.

10. The inflatable structure of claim 1, wherein at least one of the stacked bistable cells comprise:
a frame having a perimeter and recesses defined by the perimeter; and
bistable components at least partially disposed within the recesses and having a length greater than a length of the recesses; and
the bistable components have a first end and a second end, the first end of the bistable components attached to one portion of an edge of the recesses and the second end of the bistable components attached to another portion of the edge of the recesses.

11. The inflatable structure of claim 10, wherein the bistable components of one of the vertically stacked bistable cells is connected to the bistable components of another of the vertically stacked bistable cells.

12. A bistable cell comprising:
a frame having a perimeter and recesses defined by the perimeter; and
bistable components at least partially disposed within the recesses and having a length greater than a length of the recesses, wherein the bistable components are configured to change from a first state to a second state.

13. The bistable cell of claim 12, wherein the first state is a retracted state and the second state is an extended state.

14. The bistable cell of claim 12, wherein the bistable components have a first end and a second end, the first end of the bistable components attached to one portion of an edge of the recesses and the second end of the bistable components attached to another portion of the edge of the recesses.

15. The bistable cell of claim 12, wherein the bistable components are U-shaped when in the first state or the second state.

16. The bistable cell of claim 12, wherein the bistable components change from a first state to a second state when an appropriate force is placed on the bistable cell.

17. The bistable cell of claim 12, wherein lengths of one set of the bistable components are different from lengths of another set of the bistable components.

18. The bistable cell of claim 12, wherein widths of one set of the bistable components are different from widths of another set of the bistable components.

19. The bistable cell of claim 12, wherein one set of the bistable components are made of different materials than another set of the bistable components.

20. The bistable cell of claim 12, wherein:
the recesses separated by a plurality of protruding surfaces;
the protruding surfaces includes a stud;
the bistable components comprise a first end and a second end, wherein the first end includes a first socket and the second end includes a second socket; and
the first socket is coupled to a first stud associated with a first protruding surface and the second socket is coupled to a second stud associated with a second protruding surface.
